(19) United States
(12) Patent Application Publication
(10) Pub. No.: US 2025/0323551 A1
(43) Pub. Date: Oct. 16, 2025

(54) MOTOR AND METHOD FOR ASSEMBLING MOTOR

(71) Applicant: HL MANDO CORPORATION, Gyeonggi-do (KR)

(72) Inventor: Younggyu AN, Gyeonggi-do (KR)

(21) Appl. No.: 19/176,108

(22) Filed: Apr. 10, 2025

(30) Foreign Application Priority Data
Apr. 11, 2024 (KR) 10-2024-0048737

(51) Int. Cl. H02K 5/22; H02K 15/14; H02K 15/40

(52) U.S. Cl. CPC H02K 5/22; H02K 15/14; H02K 15/40

(57) ABSTRACT

In a motor and a method of assembling a motor, a coupling hole is formed in one of a housing and a fixing bracket and a plastic deformation part is formed in the other, and then stacked and fixed by caulking, so that the joining is maintained in a firm state and the defect rate can be drastically reduced, and the number of parts can be reduced and productivity can be increased without a separate fastening means.

### CROSS REFERENCE TO RELATED APPLICATION

This application claims priority from Korean Patent Application No. 10-2024-0048737 filed on Apr. 11, 2024, which is hereby incorporated by reference for all purposes as if fully set forth herein.

### TECHNICAL FIELD

Embodiments of the present disclosure relate to a motor and a method of assembling the motor by combining a housing and a bracket.

### BACKGROUND

In general, a vehicle is equipped with an electric power steering system (EPS) as a means to ensure the stability of the steering state by reducing a steering force of a steering wheel.

The electric power steering system operates a motor through an electronic controller according to the driving conditions of the vehicle detected by a vehicle speed sensor, a steering sensor, and a torque sensor, thereby providing the driver with optimal steering conditions.

That is, the electric power steering system reduces the steering force by the rotational force of the motor, thereby allowing the driver to steer easily.

If a motor of the electric power steering system causes electromagnetic interaction between a stator and a rotor through current supply, a rotation shaft rotates in conjunction with the rotor and transmits power to a steering shaft.

Here, the stator, the rotor, and rotation shaft may be installed inside a housing, and the housing is fixed by being connected to a bracket by fastening members such as bolts or rivets.

However, if the housing and the bracket are connected with fastening members such as bolts or rivets, the fastening force may be reduced and the connection cannot be maintained in a firm state, and there may occur a problem that noise and vibration occur during operation and durability may be significantly deteriorated.

### SUMMARY

Embodiments of the present disclosure may provide a motor and an assembling method thereof capable of significantly reducing the defect rate by forming a coupling hole in one of a housing and a bracket and forming a plastic part in the other, and then fixing the housing and the bracket by caulking, thereby maintaining a strong joining state, and also reducing the number of parts and increasing productivity by not using a separate fastening means.

In accordance with an aspect of the present disclosure, the present embodiments may be provided a motor including a housing having an inner space for accommodating a rotation shaft, a support hole in which the rotation shaft is rotatably installed, and at least one coupling hole located around the support hole, and a bracket coupled to the housing and having a through hole through which the rotation shaft passes, and at least one plastic part located around the through hole to correspond to a position of the at least one coupling hole of the housing, wherein the at least one plastic part of the bracket includes a protrusion inserted in the at least one coupling hole of the housing, and a catch projection having a larger diameter than the protrusion of the plastic part and supported on an inner surface of the housing.

In accordance with another aspect of the present disclosure, the present embodiments may be provided a motor including a bracket having a through hole through which a rotation shaft passes, and at least one coupling hole formed around the through hole, and a housing having a support hole in which the rotation shaft is rotatably installed, and at least one plastic part located around the support hole to correspond to a position of the at least one coupling hole and coupled to the bracket, wherein the at least one plastic part of the housing comprises a protrusion inserted in the at least one coupling hole of the bracket, and a catch projection having a larger diameter than the protrusion and supported on an outer surface of the bracket.

In accordance with another aspect of the present disclosure, the present embodiments may be provided a method of assembling a motor including forming a support hole, in which a rotation shaft is rotatably installed, on a housing, and forming at least one coupling hole around the support hole on the housing, forming a through hole, through which the rotation shaft penetrates, on a bracket, and locating at least one plastic deformable part of the bracket, disposed around the through hole of the bracket, to correspond to a position of the at least one coupling hole, mounting the housing on a support block such that the at least coupling hole of the housing is aligned with a groove of the support block, coupling the bracket to the housing such that the at least one plastic deformable part of the bracket is located in the at least one coupling hole of the housing and pressing the at least one plastic deformable part of the bracket toward the housing with a pressurizer such that the at least one plastic deformable part is deformed to form a protrusion inserted into the at least one coupling hole of the housing and a catch projection expanded from the protrusion and supported on an inner surface of the housing.

According to embodiments of the present disclosure, it is possible to provide a motor and a method assembling a motor capable of significantly reducing the defect rate by forming a coupling hole in one of a housing and a bracket and forming a plastic part in the other, and then fixing the housing and the bracket by caulking, thereby maintaining a strong joining state, and also reducing the number of parts and increasing productivity by not using a separate fastening means.

### BRIEF DESCRIPTION OF THE DRAWINGS

FIG. 1 is a cross-sectional view illustrating a motor according to the present embodiment.

FIG. 2 is an exploded perspective view illustrating a part of a motor according to the present embodiments.

FIG. 3 to FIG. 14 are cross-sectional views illustrating a part of a motor according to the present embodiments.

FIG. 15 is a flowchart illustrating a method of assembling a motor according to the present embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

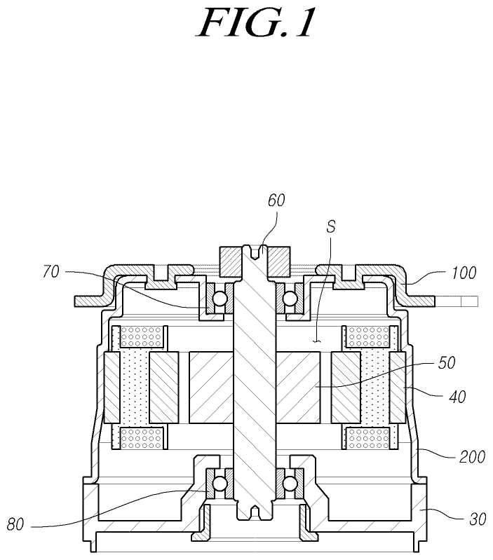

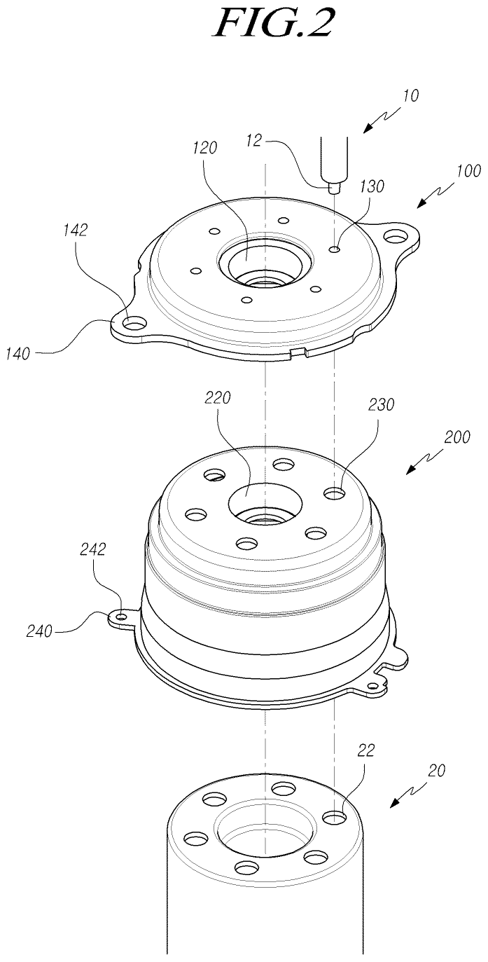

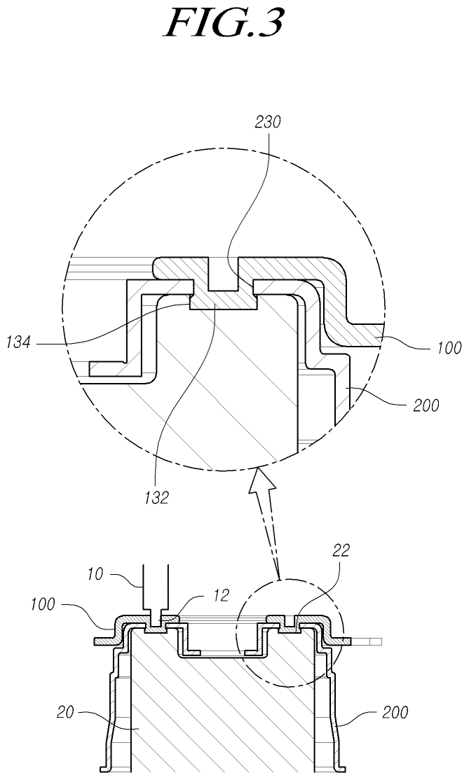

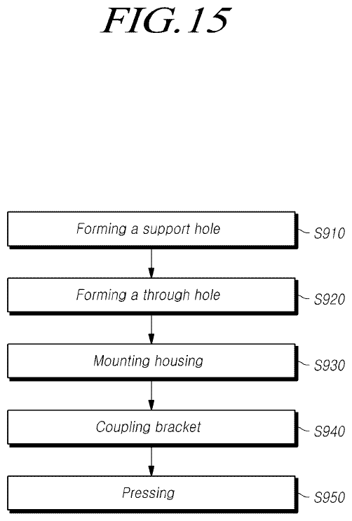

FIG. 1 is a cross-sectional view illustrating a motor according to the present embodiment, FIG. 2 is an exploded perspective view illustrating a part of a motor according to the present embodiments, FIG. 3 to FIG. 14 are cross-sectional views illustrating a part of a motor according to the present embodiments, and FIG. 15 is a flowchart illustrating a method of assembling a motor according to the present embodiment.

Referring to FIG. 1 and FIG. 2, in a motor according to the present embodiments, if electromagnetic interaction occurs between a stator 40 and a rotor 50 through current supply, a rotation shaft 60 rotates in conjunction with the rotor 50 and transmits power to a steering shaft.

The present embodiment may be applied to a column-type electric power-assisted steering device, a rack-type electric power-assisted steering device, or a steer-by-wire steering device.

A housing 200 may be formed in a substantially cylindrical shape with one side in the direction of the rotation shaft 60 closed and the other side open. In addition, an accommodation space S in which a stator 40, a rotor 50, and a rotation shaft 60 are accommodated may be formed inside the housing, and a support hole 220 in which the rotation shaft 60 is rotatably installed may be formed on one side in the axial direction.

In addition, the housing 200 is formed with a flange portion 240 protruding radially outwardly at the open end, and at least one fastening hole 242 is formed in which a fastening bolt is inserted to secure a cover 30 to the flange portion 240.

The cover 30 is coupled to the open side of the housing 200, and a support hole is formed in which the rotation shaft 60 is rotatably installed.

The stator 40 is installed in the internal accommodation space S of the housing 20 to surround the rotor 50, and a coil is wound to induce electrical interaction with the rotor 50.

The rotor 50 has a rotation shaft insertion hole formed in the center, and rotates through electrical interaction with the stator 40.

The rotation shaft 60 is coupled to the rotation shaft insertion hole to rotate together with the rotor 50 and transmit power to the steering shaft.

In this case, one side of the rotation shaft 60 is rotatably supported in the support hole 220 of the housing 200 via a first bearing 70, and the other side is rotatably supported in a support hole of the cover 30 via a second bearing 80.

The first bearing 70 is installed in the support hole 220 of the housing 200 to rotatably support one side of the rotation shaft 60.

The second bearing 80 is installed in the support hole of the cover 30 to rotatably support the other side of the rotation shaft 60.

A bracket 100 is formed in a roughly cylindrical shape with one axial side closed and the other side open, and a through hole 120 through which a rotation shaft 60 passes is formed on one axial side of the bracket.

In addition, the bracket 100 is formed with a flange portion 140 protruding radially outwardly on the open end of the other side, and at least one fastening hole 142 is formed into which a fastening bolt is inserted to fasten the flange portion 140.

A part of the housing 200 is inserted into the open end of the bracket 100, and the bracket 100 and the housing 200 are combined in a stacked state in which the axial outer surface of the housing is in contact with the axial inner surface of the bracket 100.

In one aspect, the present embodiment includes a housing 200 having an accommodating inner space S for accommodating a rotation shaft 60 therein, a support hole 220 provided on one axial side in which the rotation shaft 60 is rotatably installed, and at least one coupling hole 230 provided along a circumferential direction centered on the support hole 220, and a bracket 100 coupled to the housing 200 having a through hole 120 provided on one axial side through which the rotation shaft 60 passes, and at least one plastic part 130 provided along a circumferential direction centered on the through hole 120 to correspond to the coupling hole 230.

The housing 200 is provided with the accommodation space S in which a rotation shaft 60 is received inside, and a support hole 220 is provided on one side in the axial direction in which the rotation shaft 60 is rotatably installed, and one or more coupling holes 230 are provided along the circumferential direction centered on the support hole 220.

The bracket 100 is provided with a through hole 120 through which the rotation shaft 60 passes on one side in the axial direction, and one or more plastic parts 130 are provided along the circumferential direction centered on the through hole 120 to correspond to the coupling hole 230. In addition, the bracket 100 is coupled to the housing 200 by a pressurizing device such as a pressurizing punch 10 and a caulking tool including a support block 20.

Here, the plastic part 130 includes a protrusion 132 that is inserted into the coupling hole 230 by being pressurized by the pressurizer, and a catch projection 134 that is expanded from the protrusion 132 by a groove 22 of the support block 20 when pressurized and supported on the inner surface of the housing 200.

Referring to FIG. 3, if the plastic part 130 is the pressurized (and/or caulked) by a pressurizer 12 of t pressurizing punch 10, a part of the plastic part 130 is plastically deformed and a protrusion 132 inserted into the coupling hole 230 and a catch projection 134 expanded from the protrusion 132 by the groove 22 of the support block 20 and supported on the inner surface of the housing 200 are formed.

That is, in this embodiment, a portion of the plastic part 130 is plastically deformed by the caulking tool and inserted into the coupling hole 230 to be supported on the inner surface of the housing 200, so that the housing 200 is fixed without being detached from the bracket 100.

In this case, the housing 200 may further include an stepped portion 232 in which one or the other side of the coupling hole 230 in the axial direction is expanded in a stepwise manner so as to increase a support area of the protrusion 132.

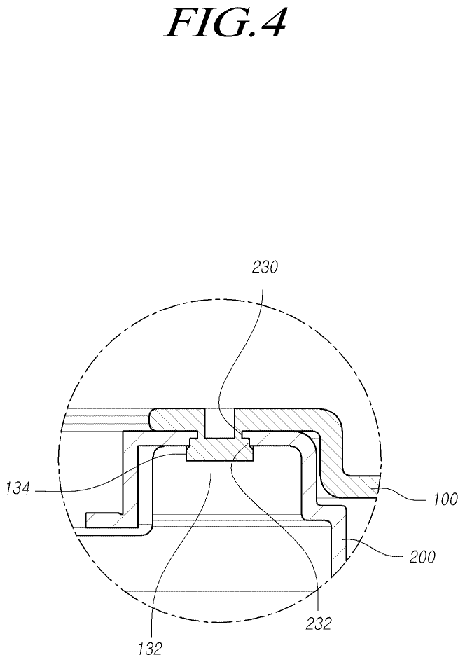

Referring to FIG. 4, the stepped portion 232 may be expanded in a stepwise manner so that the axial side of the coupling hole 230 faces the inner direction where the support block 20 is located, thereby increasing the area on which the protrusion 132 is supported.

Meanwhile, the stepped portion 232 may be expanded so that the axial side of the coupling hole 230 faces the outer direction where the pressurizer such as the pressurizing punch 10 is located, thereby increasing the area on which the protrusion 132 is supported.

In addition, the housing 200 may further include an inclined portion 233 in which one or the other axial side of the coupling hole 230 is expanded in an inclined manner so as to increase the support area of the protrusion 132.

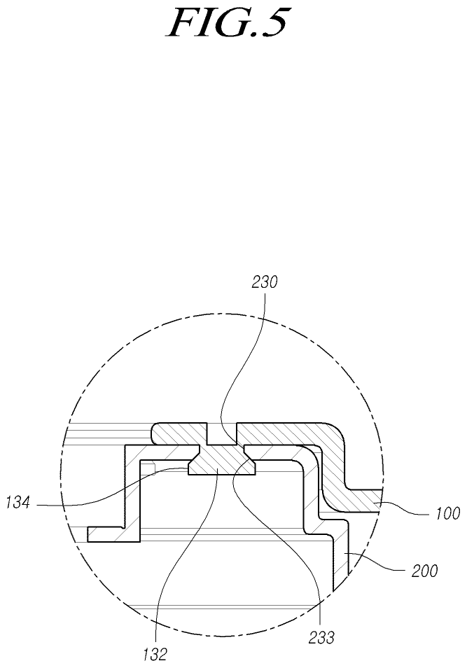

Referring to FIG. 5, the inclined portion 233 may be expanded so that the axial side of the coupling hole 230 faces the inner direction where the support block 20 is located, thereby increasing the area on which the protrusion 132 is supported.

Alternatively, the inclined portion 233 may be expanded so that the axial side of the coupling hole 230 faces the outer direction where the pressurizer such as the pressurizing punch 10 is located, thereby increasing the area on which the protrusion 132 is supported.

In addition, the housing 200 may further include a convex portion 234 formed in a convexly curved shape on the inner surface of the coupling hole 230 so as to increase the support area of the protrusion 132.

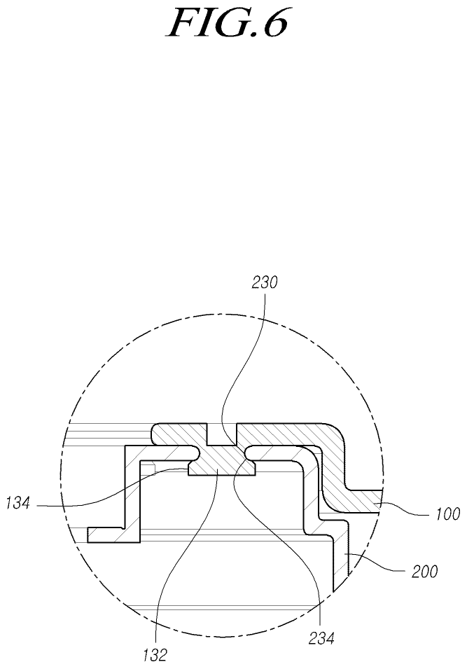

Referring to FIG. 6, the convex portion 234 may protrude in a convexly curved shape toward the center of the coupling hole 230 to increase the area on which the protrusion 132 is supported.

In addition, the housing 200 may further include a concave portion 235 formed in a concavely curved shape on the inner surface of the coupling hole 230 to increase the area on which the protrusion 132 is supported.

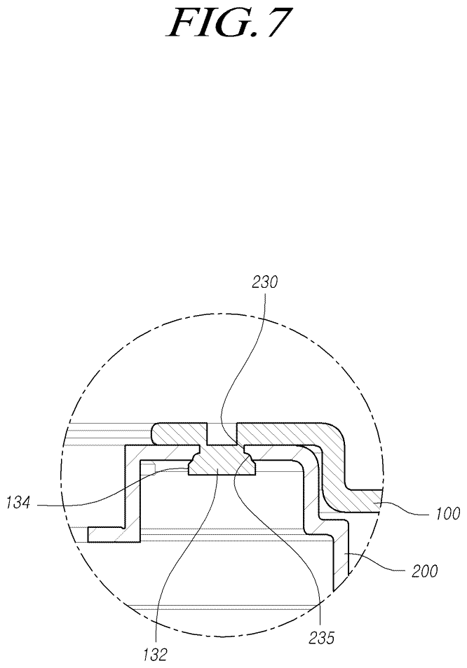

Referring to FIG. 7, the concave portion 235 may be sunken in a concavely curved shape toward the center of the coupling hole 230 to increase the area on which the protrusion 132 is supported.

In addition, the housing 200 may further include a groove 236 formed along the circumferential direction centered on the coupling hole 230 on a surface facing one axial side, and the bracket 100 may further include a projection 136 formed on a surface facing the other axial side of the plastic part 130 to correspond to the groove 236 and fitted into the groove 236.

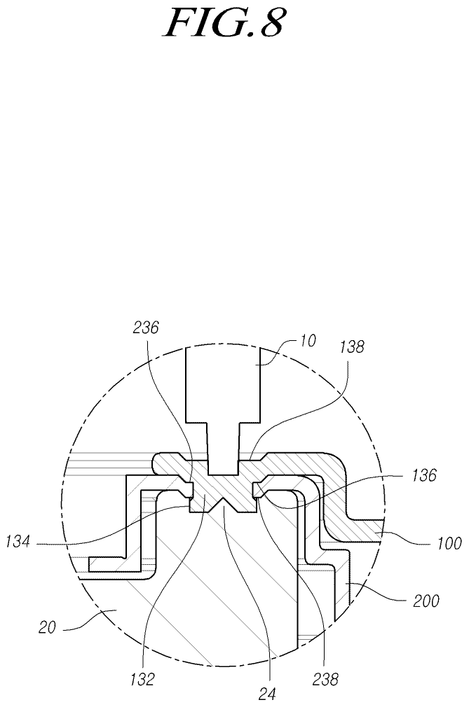

Referring to FIG. 8, the groove 236 is formed along the circumferential direction centered on the coupling hole 230 on the surface facing one axial side of the housing 200, and the projection 136 is fitted when the housing 200 is inserted into the bracket 100 during assembly.

The projection 136 is formed on the surface facing the other axial side of the plastic part 130 to correspond to the groove 236 and is fitted into the groove 236.

In addition, the housing 200 may further include a guide protrusion 238 formed along a circumferential direction centered around the coupling hole 230 on a surface facing the other axial side of the housing 200 so that the groove 22 of the support block 20 is positioned corresponding to the coupling hole 230 and inserted into the groove 22.

The guide protrusion 238 is formed in a shape protruding along a circumferential direction centered around the coupling hole 230 on a surface facing the other axial side of the housing 200 so that the groove 22 of the support block 20 is positioned corresponding to the coupling hole 230, and is inserted into the groove 22.

In addition, the bracket 100 may further include a guide groove 138 formed on a surface facing one axial side of the plastic part 130 so that the pressurizer is positioned corresponding to the plastic part 130 and into which the pressurizer 12 is inserted.

The guide groove 138 is formed in a concave shape on a surface facing one axial side of the plastic part 130 so that the pressurizer 12 of the pressurizing punch 10 is positioned corresponding to the plastic part 130 and into which the pressurizer 12 is inserted.

Here, a wedge 24 is formed protrudingly in the groove 22 of the support block 20 so that the catch projection 134 can be formed more easily.

That is, the catch projection 134 may be formed by the protrusion 132 being radially spread by the wedge 24.

In another aspect, the present embodiment includes a bracket 100 having a through hole 120 through which a rotation shaft 60 passes on one axial side, and at least one coupling hole 430 provided along a circumferential direction centered on the through hole 120, and a housing 200 having a support hole 220 in which a rotation shaft 60 is rotatably installed on one axial side, and at least one plastic part 330 provided along a circumferential direction centered on the support hole 220 to correspond to the coupling hole 430 and coupled to the bracket 100.

The bracket 100 is provided with a through hole 120 through which a rotation shaft 60 passes on one axial side. In addition, one or more coupling holes 430 may be provided along the circumferential direction centered on the through hole 120.

The housing 200 may include a support hole 220 in which a rotation shaft 60 is rotatably installed on one side in the axial direction, and one or more plastic parts 330 may be provided along the circumferential direction centered on the support hole 220 to correspond to the coupling hole 430, and the housing may be coupled to the bracket 100.

In this case, the plastic part 330 includes a protrusion 332 that is inserted into the coupling hole 430 by being pressurized by a pressurizer, and a catch projection 334 that is expanded from the protrusion 332 by the groove 22 of the support block 20 when pressurized and is supported on the outer surface of the bracket 100.

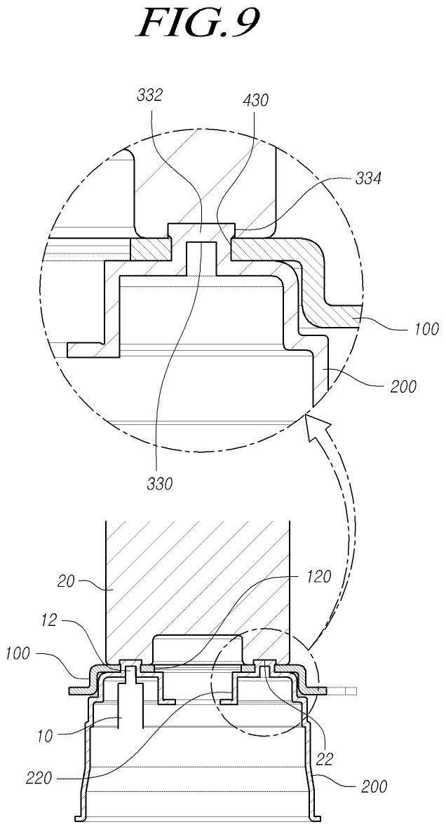

Referring to FIG. 9, when the plastic part 330 is pressed (and/or caulked) by the pressurizer 12 of the pressurizing punch 10, a portion of the plastic part 330 is plastically deformed, thereby forming a protrusion 332 inserted into the coupling hole 430 and a catch projection 334 expanded from the protrusion 332 by the groove 22 of the support block 20 and supported on the inner surface of the housing 200.

That is, in the present embodiment, a portion of the plastic part 330 is plastically deformed by the caulking tool and is inserted into the coupling hole 430 and supported on the outer surface of the bracket 100, thereby enabling the housing 200 to be coupled to the bracket 100.

In this case, the bracket 100 may include an stepped portion 432 in which one or the other axial side of the coupling hole 430 is expanded in a stepwise manner so as to increase the support area of the protrusion 332.

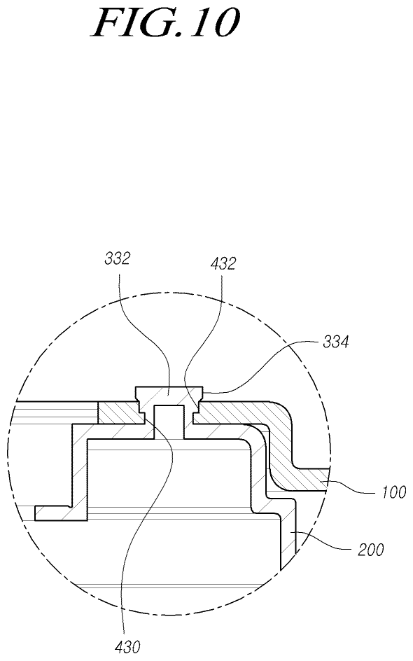

Referring to FIG. 10, the stepped portion 432 may be expanded stepwise so that one axial side of the coupling hole 430 faces the outer direction where the support block 20 is located so that the support area of the protrusion 332 increases, thereby increasing the area on which the protrusion 332 is supported.

Alternatively, the stepped portion 432 may be expanded stepwise so that the other axial side of the coupling hole 430 faces the inner direction where the pressurizer such as the pressurizing punch 10 is located so that the support area of the protrusion 332 increases, thereby increasing the area on which the protrusion 332 is supported.

In addition, the bracket 100 may include an inclined portion 433 in which one or more axial sides of the coupling hole 430 are inclinedly expanded to increase the support area of the protrusion 332.

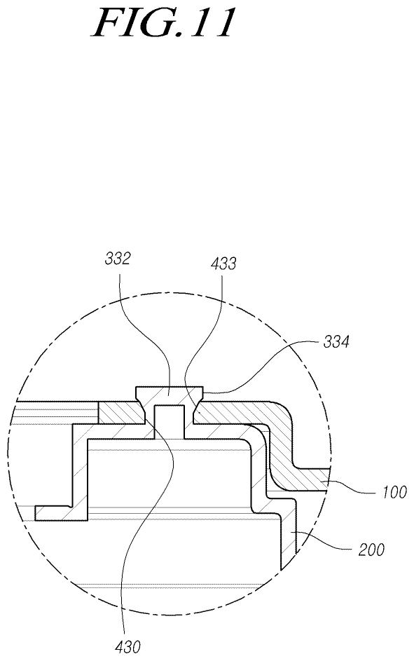

Referring to FIG. 11, the inclined portion 433 may be inclined so that one axial side of the coupling hole 430 faces the outer direction where the support block 20 is located, thereby increasing the area on which the protrusion 332 is supported.

Alternatively, the inclined portion 433 may be inclined so that the other axial side of the coupling hole 430 faces the inner direction where the pressurizer such as the pressurizing punch 10 is located, thereby increasing the area on which the protrusion 332 is supported.

In addition, the housing 200 may include a convex portion 434 formed in a convexly curved shape on the inner surface of the coupling hole 430 to increase the support area of the protrusion 332.

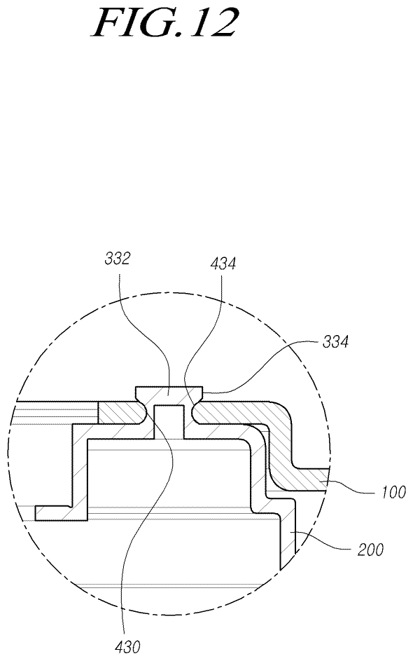

Referring to FIG. 12, the convex portion 434 may protrude in a convexly curved shape toward the center of the coupling hole 430 to increase the area on which the protrusion 332 is supported.

In addition, the housing 200 may include a concave portion 435 formed in a concavely curved shape on the inner surface of the coupling hole 430 to increase the support area of the protrusion 332.

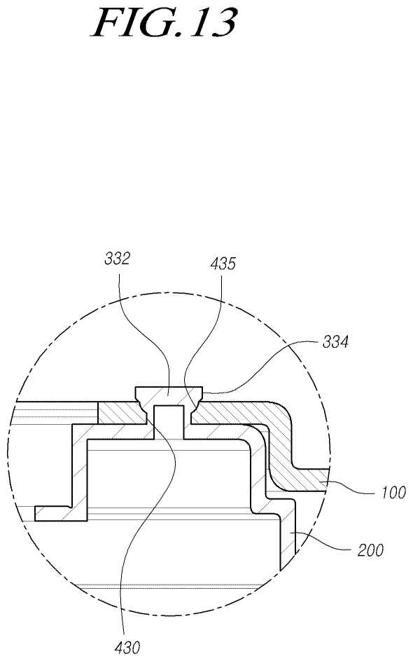

Referring to FIG. 13, the concave portion 435 may be sunken into a concavely curved shape toward the center of the coupling hole 430 to increase the area on which the protrusion 332 is supported.

In addition, the bracket 100 may include a groove 436 formed along the circumferential direction centered on the coupling hole 430 on a surface facing the other side in the axial direction, and the housing 200 may include a projection 336 formed on a surface facing one side in the axial direction of the plastic part 330 to correspond to the groove 436 and fitted into the groove 436.

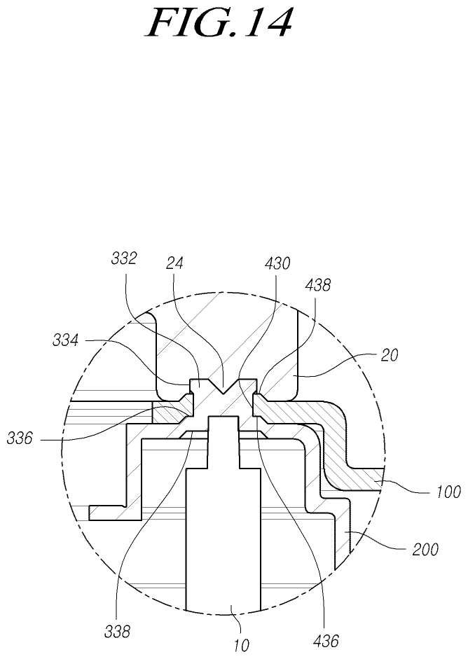

Referring to FIG. 14, the groove 436 is formed along the circumferential direction centered on the coupling hole 430 on the surface facing the other axial side of the bracket 100, and the projection 336 is fitted when the housing 200 is inserted into the bracket 100 during assembly.

The projection 336 is formed on the surface facing one axial side of the plastic part 330 to correspond to the groove 436 and is fitted into the groove 436.

In addition, the bracket 100 may include a guide protrusion 438 formed along a circumferential direction centered around the coupling hole 430 on a surface facing one side in the axial direction so that the groove 22 of the support block 20 is positioned corresponding to the coupling hole 430, and inserted into the groove 22.

The guide protrusion 438 may be formed along a circumferential direction centered around the coupling hole 430 on a surface facing one side in the axial direction of the bracket 100 so that the groove 22 of the support block 20 is positioned corresponding to the coupling hole 430, and may be inserted into the groove 22.

In addition, the housing 200 may include a guide groove 338 formed on a surface facing the axial side of the plastic part 330 so that the pressurizer is positioned at a position corresponding to the plastic part 330 and into which the pressurizer 12 is inserted.

The guide groove 338 is formed in a concave shape on the surface facing the axial side of the plastic part 330 so that the pressurizer 12 of the pressure punch 10 is positioned in a position corresponding to the plastic part 330, and the pressurizer 12 is inserted into the guide groove.

Here, a wedge 24 may be formed protrudingly in the groove 22 of the support block 20, so that the catch projection 334 can be formed more easily.

That is, the catch projection 334 may be formed by the protrusion 332 being expanded radially by the wedge 24.

In another aspect, the present embodiment may provide a method of assembling a motor including a housing forming step (S910) of forming a support hole 220 in which a rotation shaft 60 is rotatably installed on one axial side of a housing 200 and forming one or more coupling holes 230 in a circumferential direction centered on the support hole 220, a bracket forming step (S920) of forming a through hole 120 through which a rotation shaft 60 passes on one axial side of a bracket 100 and forming one or more plastic parts 130 in a circumferential direction centered on the through hole 120 to correspond to the coupling hole 230, a housing mounting step (S930) of mounting a housing 200 on a support block 20 so that the coupling hole 230 is positioned in a groove 22 of a support block 20, a bracket coupling step (S940) for coupling a bracket 100 to a housing 200 so that a plastic part 130 is positioned in a coupling hole 230, and a pressurizing step (S950) for pressing the plastic part 130 with a pressurizer to form a protrusion 132 inserted into the coupling hole 230 and a catch projection 134 expanded from the protrusion 132 and supported on the inner surface of the housing 200.

Referring to FIG. 15, the housing forming step (S910) may include forming the support hole 220 in which the rotation shaft 60 is rotatably installed on one axial side of the housing 200, and forming one or more coupling holes 230 along a circumferential direction centered on the support hole 220.

The bracket forming step (S920) may include forming the through hole 120 through which the rotation shaft 60 passes through one axial side of the bracket 100, and forming at least one plastic part 130 along the circumference centered on the through hole 120 so as to correspond to the coupling hole 230.

The housing mounting step S930 may include mounting the housing 200 on the support block 20 so that the coupling hole 230 is positioned in the groove 22 of the support block 20.

The bracket coupling step (S940) may include coupling the bracket 100 to the housing 200 so that the plastic part 130 is positioned in the coupling hole 230.

The pressurizing step (S950) may include pressurizing (and/or caulking) the plastic part 130 with the pressurizer 12 of the pressurizing punch 10 to form a protrusion 132 inserted into the coupling hole 230 and a catch projection which is expanded from the protrusion 132 and supported on the 0 inner surface of the housing 200

After the pressurizing step, a stator 40, a rotor 50, and the rotation shaft 60 may be installed inside the housing 200, and a cover 30 may be coupled to the other side of the housing 200.

Here, the housing forming step (S910) may include forming a groove 236 on a surface facing one axial side of the housing 200, and the bracket forming step (S920) may include forming a projection 136 that is fitted into the groove 236 on a surface facing the other axial side of the plastic part 130 so as to correspond to the groove 236.

In addition, the housing forming step (S910) may include forming a guide projection 238 that is inserted into the groove 22 on a surface facing the other axial side of the housing 200 so that the groove 22 of the support block 20 is positioned corresponding to the coupling hole 230.

In addition, the bracket forming step (S920) may include forming a guide groove 138 into which a pressurizer 12 is inserted on a surface facing one axial side of the plastic part 130 so that the pressurizer is positioned corresponding to the plastic part 130.

According to embodiments as described above, it is possible to a motor and a method assembling a motor capable of significantly reducing the defect rate by forming a coupling hole in one of a housing and a bracket and forming a plastic part in the other, and then fixing the housing and the bracket by caulking, thereby maintaining a strong joining state, and also reducing the number of parts and increasing productivity by not using a separate fastening means.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

The scope of protection of the present disclosure should be interpreted by the claims below, and all technical ideas within the scope equivalent thereto should be interpreted as being included in the scope of the present disclosure.

What is claimed is:

1. A motor comprising:
a housing having an inner space for accommodating a rotation shaft, a support hole in which the rotation shaft is rotatably installed, and at least one coupling hole located around the support hole; and
a bracket coupled to the housing and having a through hole through which the rotation shaft passes, and at least one plastic part located around the through hole to correspond to a position of the at least one coupling hole of the housing,
wherein the at least one plastic part of the bracket includes a protrusion inserted in the at least one coupling hole of the housing, and a catch projection having a larger diameter than the protrusion of the plastic part and supported on an inner surface of the housing.

2. The motor of claim 1, wherein the at least one coupling hole of the housing comprises a stepped portion in which an inside of the at least one coupling hole has a stepwise shape.

3. The motor of claim 1, wherein the at least one coupling hole of the housing comprises an inclined portion in which a diameter of the coupling hole gradually increases.

4. The motor of claim 1, wherein an inner surface of the at least one coupling hole of the housing has a convexly curved portion.

5. The motor of claim 1, wherein an inner surface of the at least one coupling hole of the housing has a concavely curved portion.

6. The motor of claim 1, wherein:
the housing further comprises a groove formed around the at least one coupling hole at an outer surface of the housing,
the bracket further comprises a projection formed on a surface of the bracket facing the groove of the housing, and disposed in the groove of the housing.

7. The motor of claim 1, wherein the housing further comprises a guide projection inwardly protruding around the at least one coupling hole from an inner surface of the housing.

8. The motor of claim 1, wherein the bracket further comprises a guide groove formed on a surface of the plastic part of the bracket opposite to another surface of the plastic part of the bracket facing the housing.

9. A motor comprising:
a bracket having a through hole through which a rotation shaft passes, and at least one coupling hole formed around the through hole; and
a housing having a support hole in which the rotation shaft is rotatably installed, and at least one plastic part located around the support hole to correspond to a position of the at least one coupling hole and coupled to the bracket,
wherein the at least one plastic part of the housing comprises a protrusion inserted in the at least one coupling hole of the bracket, and a catch projection having a larger diameter than the protrusion and supported on an outer surface of the bracket.

10. The motor of claim 9, wherein the at least one coupling hole of the bracket comprises a stepped portion in which an inside of the at least one coupling hole has a stepwise shape.

11. The motor of claim 9, wherein the at least one coupling hole of the bracket comprises an inclined portion in which a diameter of the coupling hole gradually increases.

12. The motor of claim 9, wherein an inner surface of the at least one coupling hole of the bracket has a convexly curved portion.

13. The motor of claim 9, wherein an inner surface of the at least one coupling hole of the bracket has a concavely curved portion.

14. The motor of claim 9, wherein:
the bracket further comprises a groove formed around the at least one coupling hole at a surface of the bracket facing the housing,
wherein the housing further comprises a projection formed on a surface of the housing facing the groove of the bracket, and disposed in the groove of the bracket.

15. The motor of claim 9, wherein the bracket further comprises a guide projection formed around the at least one coupling hole on a surface of the bracket opposite to another surface of the bracket facing the housing.

16. The motor of claim 15, wherein the housing further comprises a guide groove formed on an inner surface of the plastic part of the housing.

17. A method of assembling a motor, the method comprising:
forming a support hole, in which a rotation shaft is rotatably installed, on a housing, and forming at least one coupling hole around the support hole on the housing;
forming a through hole, through which the rotation shaft penetrates, on a bracket, and locating at least one plastic deformable part of the bracket, disposed around the through hole of the bracket, to correspond to a position of the at least one coupling hole;
mounting the housing on a support block such that the at least coupling hole of the housing is aligned with a groove of the support block;
coupling the bracket to the housing such that the at least one plastic deformable part of the bracket is located in the at least one coupling hole of the housing; and
pressing the at least one plastic deformable part of the bracket toward the housing with a pressurizer such that the at least one plastic deformable part is deformed to form a protrusion inserted into the at least one coupling hole of the housing and a catch projection expanded from the protrusion and supported on an inner surface of the housing.

18. The method of claim 17, further comprising:
forming a fitting groove on a surface of the housing facing the at least one plastic deformable part of the bracket; and
forming a fitting projection, fitted into the fitting groove of the housing, on a surface of the bracket facing the housing.

19. The method of claim 17, further comprising forming a guide projection, inserted into the groove of the support block, on an inner surface of the housing so that the groove of the support block is positioned at a position corresponding to the at least one coupling hole of the housing.

20. The method of claim 17, further comprising forming a guide groove, into which the pressurizer is inserted, on a surface of the plastic deformable part of the bracket so that the pressurizer is positioned corresponding to the plastic deformable part of the bracket.
